(19) United States
(12) Patent Application Publication
(10) Pub. No.: US 2012/0033566 A1
(43) Pub. Date: Feb. 9, 2012

(54) HYBRID FEEDBACK FOR CLOSED LOOP MULTIPLE-INPUT MULTIPLE- OUTPUT

(75) Inventors: Ron Porat, San Diego, CA (US); Maryam Shanechi, San Diego, CA (US); Uri Erez, San Diego, CA (US)

(73) Assignee: WI-LAN, INC., Ottawa, ON (CA)

(21) Appl. No.: 13/061,480

(22) PCT Filed: Aug. 28, 2009
(86) PCT No.: PCT/US09/55452

§ 371 Date: Oct. 17, 2011

Related U.S. Application Data
(60) Provisional application No. 61/092,716, filed on Aug. 28, 2008.

(51) Int. Cl. H04W 24/00

(52) U.S. Cl. 370/252

(57) ABSTRACT

The subject matter disclosed herein provides methods and apparatus for closed loop operation of a wireless system implementing multiple input and multiple output (MIMO). In one aspect, there is provided a method. The method may provide channel estimation feedback to a base station by a user equipment in a wireless communication system. The method includes receiving downlink data from the base station, calculating a digital portion representing a channel parameter estimation of the downlink data, calculating an analog portion representing an error estimation of the digital portion and providing, as feedback, the digital portion and the analog portion to the base station.

### CROSS-REFERENCE TO RELATED APPLICATIONS

This application is a national stage application of PCT Application No. PCT/US2009/055452, filed Aug. 28, 2009, which claims the benefit of U.S. Provisional Application No. 61/092,716, filed Aug. 28, 2008. All of the above referenced applications are hereby incorporated by reference herein.

### TECHNICAL FIELD

This disclosure relates to communication systems, and more particularly to a method and apparatus providing channel estimation feedback to a base station by a user equipment in a wireless communication system.

### BACKGROUND

In closed loop Multiple-Input and Multiple-Output (MIMO) systems, downlink channel information is provided back to the base station. The channel information, for example the channel matrix or its right singular vectors, are typically analog sources in nature.

For single user MIMO applications, this channel information is used at the base station to direct the transmitted power towards the mobile station. Hence accurate channel feedback in single user applications provides a signal-to-noise ratio (SNR) gain, which may result in significant throughput gains. For multi-user (MU) MIMO applications on the other hand, accurate channel state information at the transmitter (CSIT) is more important since having inaccurate CSIT incurs a significant loss in throughput and does not achieve the full multiplexing gain.

Traditionally a digital approach is taken for this problem guided by Shannon's source-channel separation theorem that proves the optimality of separate source and channel coding. In this approach, the source is first quantized and then the quantization bits are coded using a channel code to recover the quantized source with low error probability at the base station. One drawback of a digital scheme however, is the threshold effect, which means that the digital system achieves the desired performance only at the specific designed SNR. At any lower SNR, system performance is typically sacrificed and at any higher SNR, system performance does not improve. Since the exact feedback channel SNR is unknown and belongs to a range, the digital approach for channel feedback is typically suboptimal. Another shortcoming of this approach, even for a single SNR, is that long source and channel codes are needed to achieve an optimal performance, which is not possible over a fast feedback link. It is desirable to design a single transmission scheme that will be simultaneously good for the entire SNR range over a fast link.

Analog transmission of the source on the other hand, allows a graceful degradation of performance at low SNR and does not saturate at high SNR. However, it is typically optimal for transmitting a Gaussian source over a Gaussian channel where the source bandwidth is the same as the channel bandwidth. In some cases however, the channel bandwidth may be greater than the source bandwidth and hence a pure analog scheme may be suboptimal as well.

### SUMMARY

Methods and apparatuses of providing channel estimation feedback to a base station by a user equipment in a wireless communication system are described herein.

In an exemplary embodiment of the present disclosure, there is a method of providing channel estimation feedback to a base station by a user equipment in a wireless communication system. The method includes receiving downlink data from the base station, calculating a digital portion representing a channel parameter estimation of the downlink data, calculating an analog portion representing an error estimation of the digital portion and providing, as feedback, the digital portion and the analog portion to the base station.

In yet another exemplary embodiment, there is a user equipment. The user equipment including a receiving unit configured to receive downlink data from a base station, a processor coupled to the receivers and configured to generate feedback in the form of digital information representing a channel parameter estimation of the downlink data, and analog information representing an error estimation of the channel parameter estimation, and a transmitting unit configured to transmit the feedback to the base station, wherein the digital information is provided in the form of one or more singular vectors to form a matrix of singular vectors.

In still another exemplary embodiment, there is an apparatus. The apparatus including a receiving unit for receiving and decoding feedback received from a user equipment in the form of a digital information representing quantized channel estimation information and an analog information representing an error estimation of the digital information, and a transmitting unit adapted to adjust a transmission parameter based on the feedback and configured to transmit downlink data to a user equipment.

The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts a block diagram of a network including client stations and base stations;

FIG. 2 depicts a block diagram of a client station including a channel estimator;

FIG. 3A depicts a process for hybrid feedback for closed loop MIMO;

FIG. 3B depicts a hybrid data mapping on a single tile;

FIG. 4 depicts a block diagram of a channel estimator;

FIG. 5 depicts a block diagram of a base station including a channel estimator; and

FIG. 6 depicts a process, at the base station, configured to use hybrid feedback for closed loop MIMO.

### DETAILED DESCRIPTION

Throughout this description, the examples shown should be considered as exemplars, rather than as limitations on the present disclosure.

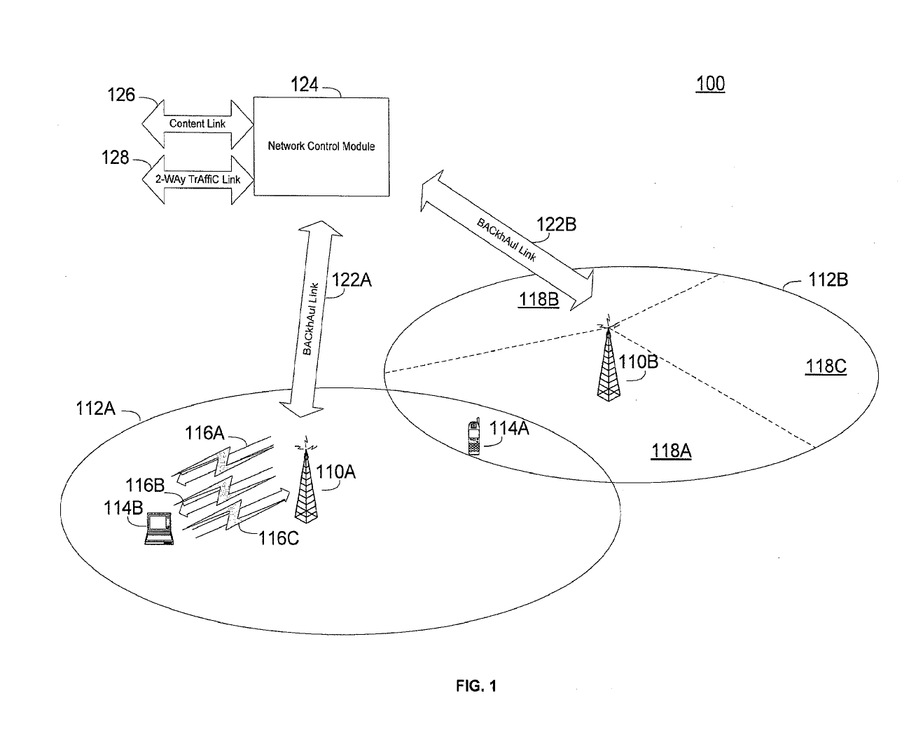

FIG. 1 is a simplified functional block diagram of an embodiment of a wireless communication system 100. The wireless communication system 100 includes a plurality of base stations 110A and 110B, each supporting a corresponding service or coverage area 112A and 112B. The base stations are capable of communicating with wireless devices within their coverage areas. For example, the first base station 110A is capable of wirelessly communicating with a first client station 114A and a second client station 114B within the coverage area 112A. The first client station 114A is also within the coverage area 112B and is capable of communicating with the second base station 110B. In this description, the communication path from the base station to the client station is referred to as a downlink 116A and the communication path from the client station to the base station is referred to as an uplink 116B.

Although for simplicity only two base stations are shown in FIG. 1, a typical wireless communication system 100 includes a much larger number of base stations. The base stations 110A and 110B can be configured as cellular base station transceiver subsystems, gateways, access points, radio frequency (RF) repeaters, frame repeaters, nodes, or any wireless network entry point.

The base stations 110A and 110B can be configured to support an omni-directional coverage area or a sectored coverage area. For example, the second base station 110B is depicted as supporting the sectored coverage area 112B. The coverage area 112B is depicted as having three sectors, 118A, 118B, and 118C. In typical embodiments, the second base station 110B treats each sector 118 as effectively a distinct coverage area.

Although only two client stations 114A and 114B are shown in the wireless communication system 100, typical systems are configured to support a large number of client stations. The client stations 114A and 114B can be mobile, nomadic, or stationary units. The client stations 114A and 114B are often referred to as, for example, mobile stations, mobile units, subscriber stations, wireless terminals, or the like. A client station can be, for example, a wireless handheld device, a vehicle mounted device, a portable device, client premise equipment, a fixed location device, a wireless plug-in accessory or the like. In some cases, a client station can take the form of a handheld computer, notebook computer, wireless telephone, personal digital assistant, wireless email device, personal media player, meter reading equipment or the like and may include a display mechanism, microphone, speaker and memory.

In a typical system, the base stations 110A and 110B also communicate with each other and a network control module 124 over backhaul links 122A and 122B. The backhaul links 122A and 122B may include wired and wireless communication links. The network control module 124 provides network administration and coordination as well as other overhead, coupling, and supervisory functions for the wireless communication system 100.

In some embodiments, the wireless communication system 100 can be configured to support both bidirectional communication and unidirectional communication. In a bidirectional network, the client station is capable of both receiving information from and providing information to the wireless communications network. Applications operating over the bidirectional communications channel include traditional voice and data applications. In a unidirectional network, the client station is capable of receiving information from the wireless communications network but may have limited or no ability to provide information to the network. Applications operating over the unidirectional communications channel include broadcast and multicast applications. In one embodiment, the wireless system 100 supports both bidirectional and unidirectional communications. In such an embodiment, the network control module 124 is also coupled to external entities via, for example, content link 126 (e.g., a source of digital video and/or multimedia) and two-way traffic link 128.

The wireless communication system 100 can be configured to use Orthogonal Frequency Division Multiple Access (OFDMA) communication techniques. For example, the wireless communication system 100 can be configured to substantially comply with a standard system specification, such as IEEE 802.16 and its progeny or some other wireless standard such as, for example, WiBro, WiFi, Long Term Evolution (LTE), or it may be a proprietary system. The subject matter described herein is not limited to application to OFDMA systems or to the noted standards and specifications. The description in the context of an OFDMA system is offered for the purposes of providing a particular example only.

As used herein, IEEE 802.16 refers to one or more Institute of Electrical and Electronic Engineers (IEEE) Standard for Local and metropolitan area networks, Part 16: Air Interface for Fixed Broadband Wireless Access Systems, 1 Oct. 2004, IEEE Standard for Local and metropolitan area networks, Part 16: Air Interface for Fixed and Mobile Broadband Wireless Access Systems, 26 Feb. 2006, and any subsequent additions or revisions to the IEEE 802.16 series of standards.

In some embodiments, downlinks 116A-B and uplink 116C each represent a radio frequency (RF) signal. The RF signal may include data, such as voice, video, images, Internet Protocol (IP) packets, control information, and any other type of information. When IEEE-802.16 is used, the RF signal may use OFDMA. OFDMA is a multi-user version of orthogonal frequency division multiplexing (OFDM). In OFDMA, multiple access is achieved by assigning to individual users groups of subcarriers (also referred to as tones). The subcarriers are modulated using BPSK (binary phase shift keying), QPSK (quadrature phase shift keying), QAM (quadrature amplitude modulation), and carry symbols (also referred to as OFDMA symbols) including data coded using a forward error-correction code.

In some embodiments, a base station is implemented using multiple-input and multiple-output (MIMO). When MIMO is used, a base station may include a plurality of antennas. For example, base station 110A may be configured for MIMO and include a precoder (described further below) coupled to two antennas for the MIMO transmission via downlinks 116A-B. The precoder is configured to perform “precoding,” which refers to beamforming to support MIMO transmission at each of the antennas (e.g., using singular vectors to weight orthogonal “eigen-beams” transmitted via each of the antennas). A client station may include a plurality of antennas to receive the MIMO transmission sent via downlinks 116A-B. The client station may also combine the received signals, which may result in fewer errors and/or enhanced data transfer. Although the examples given herein are made in the context of MIMO, other smart antenna techniques may be used as well including MISO (multiple input, single output) and SIMO (single input, multiple output).

Moreover, when MIMO is used, the base station may perform precoding (which may use channel estimation information) to code, for each antenna, one or more streams of symbols for transmission over the corresponding antenna. In a closed loop feedback-based approach, the channel estimation information is provided by the client station to the base station. For example, a client station may receive each of the downlinks 116A-B transmitted by the antennas of the base station, decode the received downlink signals, determine channel estimation information for the decoded channels (e.g., subcarriers) in each of the received downlink signals, and then provide to the base station the determined channel estimation information, which serves as feedback. The channel estimation information provided by the client station may include singular vectors determined by the client station using a singular value decomposition (SVD) and an error signal (which is described further below). Although the information that is used as feedback is described herein as including singular vectors, the feedback may include one or more of the following as well: a channel matrix, a channel covariance matrix, an SV′, an R (i.e., upper matrix from a QR decomposition of the channel), and the like.

The singular vectors may be determined for each of the channels (e.g., subcarriers) used by the antennas transmitting from the base station to the client station. For example, the base station may include two antennas, each of which transmits over a channel comprising one or more subcarriers. The client station may then determine singular vectors for the subcarriers. The singular vectors may be configured into a matrix, V, which is also referred to as a matrix of right singular vectors or, more simply, the matrix V.

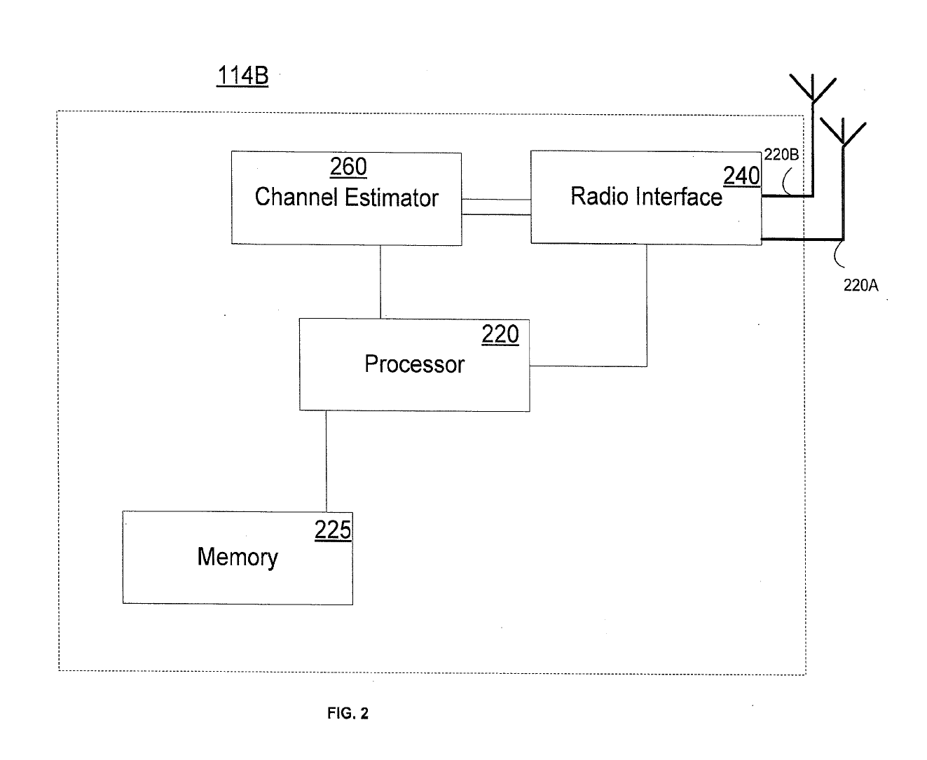

FIG. 2 depicts an exemplary client station, such as client station 114B. The client station 114B includes a plurality of antennas 220A-B for receiving the downlinks 116A-B, each transmitted by a base station, such as base station 110A, which implements MIMO as described further below. Although the examples described herein refer to two antennas at the base station and two antennas at the client station, other quantities of antennas can be used at the base station and the client station. The client station 114B also includes a radio interface 240, which may include other components, such as filters, converters (e.g., digital-to-analog converters and the like), symbol demappers, an Inverse Fast Fourier Transform (IFFT) module, and the like, to process the received MIMO transmission sent via downlinks 116A-B, to determine channel estimation information, and to decode any data, such as the symbols, carried by the downlinks. In some implementations, the client station 114B is also compatible with IEEE 802.16 and MIMO transmissions (which are sent via downlinks 116A-B), although MIMO implementations using other wireless technologies, such as LTE, WiBro, and the like, may also be implemented using the subject matter described herein. The client station 114B further includes a channel estimator 260 (described further below), a processor 220 for controlling client station 114B and for accessing and executing program code stored in memory 225.

For each of the MIMO transmissions sent via downlinks 116A-B and received at each of antennas 220A-B, the channel estimator 260 may determine channel estimation information, such as the singular vectors determined using a singular value decomposition, and then feedback that information and other information as part of a closed loop MIMO feedback to the base station. Moreover, the feedback from the client station to the base station may be in the form of a hybrid of analog information and digital information. For example, the digital information may include quantized channel estimation information, such as one or more singular vectors of the matrix V, and the analog information may include an error signal representative of the error of the quantized singular vectors of matrix V, when compared to the original, un-quantized singular vectors of matrix V (which has been aligned as described further below).

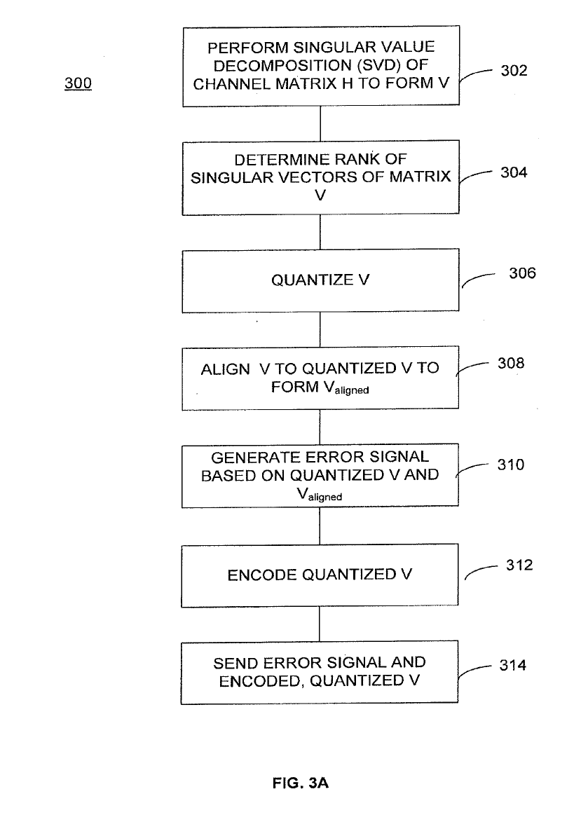

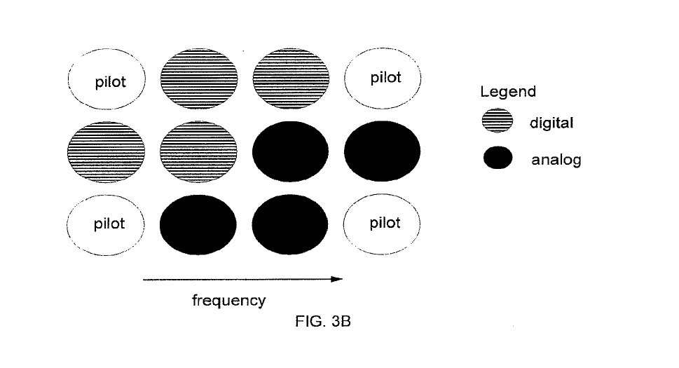

FIG. 3A depicts a process 300 for providing hybrid feedback (e.g., analog information and digital information). Although the description herein describes the feedback being sent from a client station to a base station, this implementation is only exemplary as the feedback process 300 can be used by any receiver to feedback information to a transmitter (e.g., a base station may use process 300 to feedback information to a client station, which is transmitting on an uplink to the base station). The description of process 300 will also refer to FIG. 2.

At 302, a singular value decomposition is performed of channel matrix, H. For example, channel estimator 260 at client station 114B may perform a singular value decomposition to form the matrix V including singular vectors, such as vectors v₁, v₂, v₃, and so forth until the last singular vector of that matrix. The singular value decomposition may be performed in a variety of ways and may take the following form:

H=USV*,

wherein H represents the channel estimation matrix, U represents a matrix of left singular vectors, S represents a diagonal matrix whose diagonal elements are the singular values of H, and V* represents a matrix of right singular vectors. The asterisk (*) represents that the matrix V is a conjugate transpose.

It should be noted that alternate methods, such as but not limited to the well known power method and closed form singular value decomposition, may be used to form the matrix V of singular vectors from the channel matrix H. The present Applicant has earlier provided additional details of forming matrix V of singular vectors from the channel matrix H in PCT Patent Application Number PCT/US2009/049851, entitled CLOSED FORM SINGULAR VALUE DECOMPOSITION, filed on Jul. 7, 2009, which is incorporated herein by reference.

At 304, the singular vectors of the matrix V* are used to calculate a transmission rank, rₒₚₜ, based on a desired criterion. For example, an optimal rank that maximizes capacity can be determined using the following formula:

$${r}_{opt} = {argmax}_{r} {C}_{r} = {argmax}_{r} log det ( I + \frac{S N R}{r} {HV}_{1 : r} {V}_{1 : r}^{*} {H}^{*} )$$

In this example, singular vectors v₁, v₂, v₃, and so forth of matrix V* are the columns of that matrix that provide a maximum capacity on the channel. Rank adaptation may be used in single user MIMO whereby a mobile station decides on the rank r of the precoder and sends back the first r strongest singular vectors. Similarly for MU-MIMO a user can send a hybrid version of the r strongest singular vectors.

At 306, one or more of the singular vectors of matrix V* are quantized using a k bit unitary codebook with the mapping criterion of interest such as maximum capacity criterion. The resulting quantization bits are denoted by (b₁, . . . ,bₖ) and the quantized V by \hat{V}.

At 308, an alignment is conducted to align the original, un-quantized matrix V* to the quantized matrix V by performing a unitary transformation on V. Since the precoder V is invariant to unitary transformations on the right, a goal is to find the unitary transformation matrix Qₒₚₜ such that

$${Q}_{opt} = {argmin}_{Q} {‖ \hat{V} - VQ ‖}_{F}^{2} .$$

Qₒₚₜ is given by Qₒₚₜ=V_{corr}U*_{corr} where V_{corr} and U_{corr} are the right and left singular vectors of the correlation matrix, \hat{V}*V, respectively, i.e., \hat{V}*V=U_{corr}ΣV*_{corr}. The aligned V is denoted by Vₐ=VQₒₚₜ. It should be noted that for rank-1 precoding, the unitary transformation becomes a phase rotation:

$${e}^{jφ} = \frac{{V}^{*} \hat{V}}{\vert {V}^{*} \hat{V} \vert} .$$

Alternatively for rank-2 or higher, one can use a diagonal unitary rotation matrix whereby each column of V is independently phase aligned.

During the alignment, the phase of un-quantized matrix V* is adjusted to attempt alignment to the quantized matrix \hat{V}. The resulting aligned, un-quantized matrix is referred to as Va.

At 310, an analog error signal is generated. The analog error signal represents the error between the quantized, matrix \hat{V} and the un-quantized, aligned matrix Va (also referred to as V_{aligned}). In some embodiments, the error signal may be determined based on the following equation:

error signal E=\hat{V}-Vₐ.

At 312, the quantized matrix \hat{V} is encoded. For example, channel estimator 260 may use a short algebraic code, such as Reed-Muller code, to encode the quantization bits (b₁, . . . ,bₖ) of quantized matrix \hat{V} into a codeword, such as (c₁, . . . ,cₙ), wherein c₁ represents the first bit of the codeword and cₙ represents the last bit of the codeword.

At 314, the analog error signal generated at 310 and the codeword of the quantized matrix \hat{V} formed at 312, are provided (e.g., sent), as feedback, by the channel estimator 260 from the client station 114B to a base station. This feedback is a hybrid feedback, which includes an analog portion (e.g., the analog error signal generated at 310) and a digital portion (e.g., codeword of the quantized matrix \hat{V} formed at 312). Moreover, this feedback information enables the base station to configure precoding for MIMO transmission at the base station. For the plurality of subcarriers of a band, an average singular vector may be determined, the aligned average singular vector representative of the plurality of subcarriers of the band. The aligned average singular vector may be provided, as the hybrid feedback to a precoder at a base station. Further detail on creating an average singular vector was described earlier by the Applicant in PCT Patent Application Number PCT/US2009/049852, filed Jul. 7, 2009, entitled IMPROVED PRECODER FOR MULTIPLE-SUBCARRIER BAND FEEDBACK, herein incorporated by reference in its entirety.

In an embodiment, the digital data is constructed by using a 4 or 6 bit codebook quantizers for both rank 1 and rank 2 transmissions. To encode the 4 bits, for example, the (8,4,4) extended Hamming, i.e., Reed-Muller code RM (3,1), is used. The digital part of hybrid information which consists of 8 coded bits will occupy 4 subcarriers, i.e., QPSK symbols.

Furthermore, 2 tiles are used as the basic uplink transmission unit. If rank 2 transmission is used the analog error will have 8 analog symbols occupying 8 subcarriers. If rank 1 transmission is used, the analog error will have 4 analog symbols which will occupy 4 subcarriers.

In rank 1 transmission, the digital and analog data are mapped into the first tile as shown in FIG. 3B and then repeated over the second tile. For rank 2 transmission, the digital data is repeated and sent over the 2 tiles just as in rank 1 transmission. Specifically, the first 4 symbols of the analog error are sent on the analog positions of the first tile as shown in FIG. 3B and the last 4 symbols are sent on the analog positions of the second tile.

Before placing the 8 analog symbols on the tiles, a unitary transformation is applied on them using an 8 dimensional rotational unitary matrix, φ₈, constructed according to

$${Φ}_{n} = [ \begin{matrix}{Φ}_{n / 2} cos θ & {Φ}_{n / 2} sin θ \\ - {Φ}_{n / 2} sin θ & {Φ}_{n / 2} cos θ\end{matrix} ]$$

where φ₂ is the standard 2 dimensional rotation matrix

$${Φ}_{2} [ \begin{matrix}cos θ & sin θ \\ - sin θ & cos θ\end{matrix} ]$$

and θ is a properly chosen angle. These rotational matrices can be reversed at the user equipment and provide more diversity gain on the analog data over 2 tiles and protect it from deep fades. It should be noted that for

$$θ = \frac{Π}{4} ,$$

the rotational matrices reduce to the well-known Walsh-Hadamard matrices.

The mobile can alternatively decide to transmit on 4 or 6 tiles in which case the 2 tile structure will just be repeated for 4 and 6 tile transmissions. This will result in increased diversity. Furthermore, repeating the digital data on two different tiles as opposed to the same tile provides more diversity gain.

To satisfy the power constraint, the average power per subcarrier is set to 1 (or equivalently per tile to be 8). Furthermore, the same scaling factor for both digital and analog data is used. However, since the digital data is mapped to a QPSK constellation and has constant power of 1 per subcarrier and the analog data is an error term and has much lower average power, the analog error is first boosted by a known factor, β, which is a design parameter that could be selected based on the application.

In an embodiment, the resulting analog average power is the same as the digital power as it provides good balance between the detection of the digital and analog portions. Hence, writing the power equation for the basic transmission unit of 2 tiles provides:

$$16 = {α}^{2} ( {P}_{digital} + {β}^{2} {‖ E ‖}_{F}^{2} ) = {α}^{2} ( 8 + {β}^{2} {‖ E ‖}_{F}^{2} ) , wherein$$

$$α = \sqrt{\frac{16}{8 + {β}^{2} {‖ E ‖}_{F}^{2}}} .$$

At the receiver, this factor can be estimated by finding the ratio of the average power of the pilot signal to the average power of the digital part of the data since the pilots all have power 1.

At the receiver, the digital part of the feedback data is first combined using a Maximal Ratio Combiner (MRC) and then a Maximum Likelihood (ML) decoder is used to decode the Hamming code. Assuming that the ith coded bit sees an equivalent vector channel k (resulting from both the SIMO channel and repetition), i.e., \vec{y}ᵢ=\vec{h}ᵢ\vec{c}ᵢ+\vec{n}, then the corresponding MRC performs the following operation on the ith received vector:

$${\hat{y}}_{i} = \frac{{{h}^{->}}_{i}^{*}}{‖ {{h}^{->}}_{i} ‖} {{y}^{->}}_{i} .$$

An ML decoder is then used on the combined symbols to decode the digital code as follows:

$$( {c}_{1}^{opt} , … , {c}_{n}^{opt} ) = {argmax}_{( {c}_{1} , … , {c}_{n} ) ∈ RM ( 3 , 1 )} \sum {\vert {\hat{y}}_{i} - ‖ {{h}^{->}}_{i} ‖ {c}_{i} \vert}^{2}$$

The analog portion of the data is reconstructed using a linear estimator. Assuming the equivalent vector channel on the ith analog symbol, eᵢ, is given by \vec{h}ᵢ, i.e., \vec{y}ᵢ=\vec{h}ᵢeᵢ+\vec{n}, the estimator is given by

$${\hat{e}}_{i} = \frac{{{h}^{->}}_{i}^{*}}{{‖ {{h}^{->}}_{i} ‖}^{2} + 1 / S N R} {{y}^{->}}_{i} .$$

The precoder V is then reconstructed by adding the reconstructed analog error to the decoded quantized precoder.

In an alternate embodiment, the hybrid algorithm could send other quantities such as H, SV, QR, or P. This can be achieved with proper vector or scalar quantizers for these quantities. For example a scalar quantizer can be designed for the elements of a Raleigh faded H by using 1 quantization bit for the real and 1 quantization bit for the imaginary of each element. Since the elements of H, i.e., hᵢⱼ's, are Gaussian, the following scalar quantizer for the Gaussian variables can be used:

$$q ( x ) = \{ \begin{matrix}\sqrt{\frac{2}{Π}} σ & if x \geq 0 \\ - \sqrt{\frac{2}{Π}} σ & if x < 0\end{matrix}$$

where σ is the standard deviation of the real and imaginary parts of hᵢⱼ's and in the case of Raleigh fading channel is equal to \sqrt{0.5}.

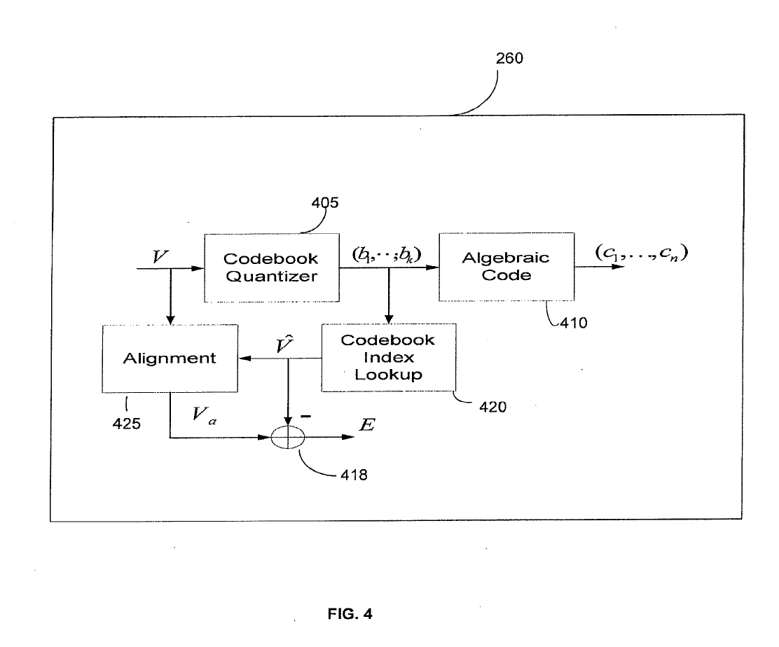

FIG. 4 depicts an example implementation of the algorithm 260. In the depicted implementation, algorithm 260 includes a codebook quantizer 405 for receiving the unquantized matrix V and quantizing that matrix into bits b₁-bₖ using a codebook. The algorithm 260 further includes a code 410 for encoding the bits b₁-bₖ into a digital codeword. The code could be, for example, an algebraic code, a convolutional code or any related code. An example, of an algebraic code is the Reed-Muller code. The algorithm also includes an alignment module 415 to perform the alignment described above with respect to 320. The algorithm further includes a difference module 418 to generate the error signal based on the aligned matrix Va and the quantized matrix formed at 306. The codebook index lookup 420 transforms back the transmitted bits (which are the index to the codebook table) into the actual codeword.

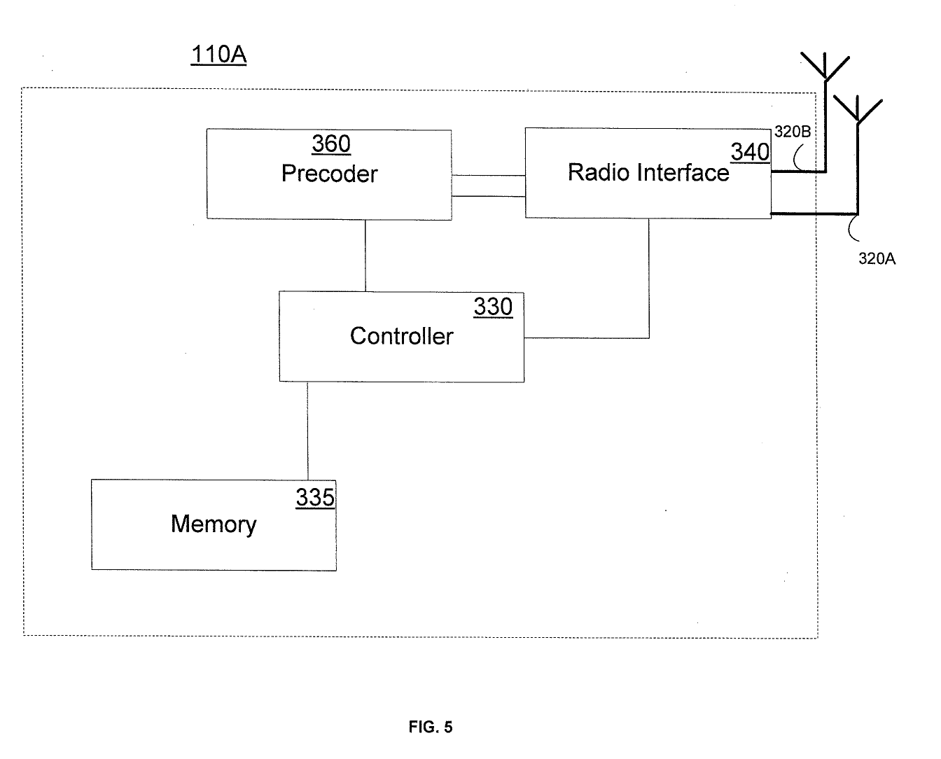

FIG. 5 depicts a base station, such as base station 110A. The base station 110A includes antennas 320A-B configured to transmit via downlinks 116A-B and configured to receive uplink 116C via at least one of antennas 320A-B. The base station 110A further includes a radio interface 340 coupled to the antennas 320A-B, a precoder 360 (described further below), a processor 330 for controlling base station 110A and for accessing and executing program code stored in memory 335. The radio interface 340 further includes other components, such as filters, converters (e.g., digital-to-analog converters and the like), mappers, a Fast Fourier Transform (FFT) module, and the like, to generate a MIMO transmission via downlinks 116A-B to receive the channel estimation information provided via uplink 116C, and to receive feedback from client station 114B. The received feedback is used at precoder 360. In some implementations, the base station 110A is also compatible with IEEE 802.16 and the RF signals of the MIMO downlinks 116A-B and uplink 116C are configured in accordance with OFDMA.

The radio interface 340 decodes the uplink 116C carrying the feedback, such as a hybrid feedback including an analog portion (e.g., the analog error signal generated at 310) and a digital portion (e.g., codeword of the quantized matrix P formed at 312). The radio interface 340 may also decode uplink 116C carrying any feedback information (e.g., the hybrid analog and digital feedback information sent at 335 from the client station to the base station), which are provided to the precoder 360. The precoder 360 is configured in accordance with the hybrid feedback information, which is received.

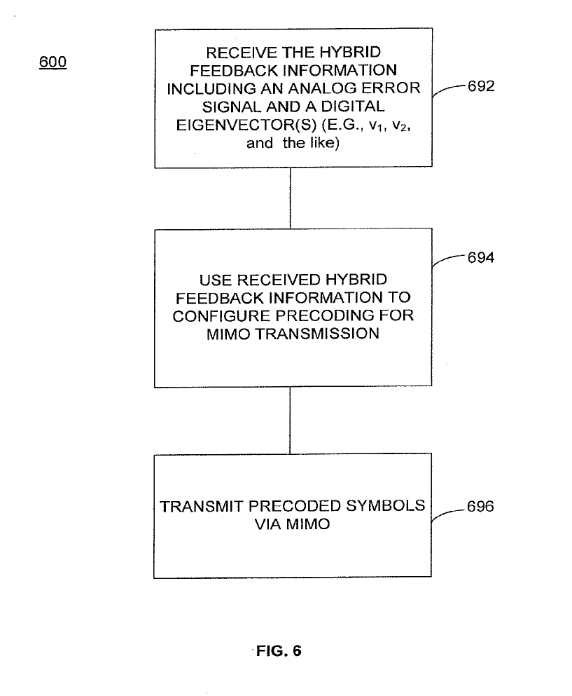

FIG. 6 depicts a process 600 to configure a base station to use the hybrid feedback information, which is provided as feedback from the client station to the base station. The description of process 600 will refer to FIG. 5 as well.

At 692, a base station, such as base station 110A, receives from a client station hybrid feedback information, such as the information sent at 314 above. In some embodiments, the hybrid feedback information (e.g., including an analog portion, such as the analog error signal generated at 310, and a digital portion, such as a codeword of the quantized matrix P formed at 312) may be received in a tile format.

At 694, the received hybrid feedback information is provided to a precoder, such as precoder 360 to configure the precoder 360 for MIMO transmission. The precode 360 combines the received information (e.g., the received analog error and the received quantized V to form the matrix V, which includes singular vectors v₁ and v₂). These singular vectors v₁ and v₂ (as well as any other channel estimation information provided as feedback by the client station to the base station) enable the precoder 360 to precode, based on a singular value decomposition using matrix V, one or more symbols streams for MIMO transmission via antennas 320A-B. Although the description refers to using two singular vectors v₁ and v₂, other quantities of singular vectors may be used as well.

At 696, the base station 110A transmits to the client station based on the precoded symbols via MIMO.

Although the above describes the embodiments using vectors and matrixes, the vectors and matrixes may be implemented as any type of data container and/or data structure, as well.

The subject matter described herein may be embodied in systems, apparatus, methods, and/or articles depending on the desired configuration. Base station 110A (or one or more components therein) can be implemented using one or more of the following: a processor executing program code, an application-specific integrated circuit (ASIC), a digital signal processor (DSP), an embedded processor, a field programmable gate array (FPGA), and/or combinations thereof. Client station 114B (or one or more components therein) can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object- oriented programming language, and/or in assembly/machine language. As used herein, the term “machine-readable medium” refers to any computer program product, computer-readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

What is claimed:

1. A method comprising:
receiving downlink data from the base station;
calculating a digital portion representing a channel parameter estimation of the downlink data;
calculating an analog portion representing an error estimation of the digital portion; and
providing, as feedback, the digital portion and the analog portion to the base station.

2. The method of claim 1, wherein the wireless communication system supports Orthogonal Frequency Division Multiplexing/Orthogonal Frequency Division Multiple Access (OFDM/OFDMA).

3. The method of claim 1, wherein the digital portion is a digital codeword.

4. The method of claim 1, wherein the feedback signal is used to adapt transmission at the base station.

5. The method of claim 1, further comprising:
performing a QR decomposition of the downlink data to form an orthogonal and a right triangular matrix.

6. The method of claim 1, wherein the analog and digital portions are superposed on the same set of OFDM/OFDMA subcarriers.

7. The method of claim 1, wherein the analog and digital portions are each allocated their own set of OFDM/OFDMA subcarriers.

8. The method of claim 1, wherein the channel parameter estimation comprises a matrix of singular vectors.

9. The method of claim 8, wherein the matrix of singular vectors is generated by performing a singular value decomposition or a power method.

10. The method of claim 9, further comprising:
calculating a transmission rank based on a criterion established for a transmission parameter.

11. The method of claim 10, wherein the criterion is maximizing transmission capacity.

12. The method of claim 10, further comprising:
quantizing the matrix of singular vectors using a k-bit unitary codebook and the criterion to form a k-bit series of quantization bits and a quantized matrix of singular vectors.

13. The method of claim 12, wherein the k-bit series of quantized bits are encoded using a code to form the digital codeword.

14. The method of claim 12, wherein k is 4 or 6.

15. The method of claim 12, further comprising:
performing unitary transformation, based on the transmission rank, on the quantized matrix of singular vectors to align the quantized matrix of singular vectors to the unquantized matrix of singular vectors to form an aligned matrix of singular vectors.

16. The method of claim 15, wherein the analog portion further represents the error between the quantized matrix of singular vectors and the aligned matrix of singular vectors.

17. A user equipment, comprising:
a receiving unit configured to receive downlink data from a base station;
a processor coupled to the receivers and configured to generate feedback in the form digital information representing a channel parameter estimation of the downlink data, and analog information representing an error estimation of the digital information; and
a transmitting unit configured to transmit the feedback to the base station, wherein the digital information is provided in the form of one or more singular vectors to form a matrix of singular vectors.

18. The user equipment of claim 17, wherein the processor is further configured to calculate a transmission rank based on a criterion established for a transmission parameter.

19. The user equipment of claim 18 wherein the criterion is maximizing transmission capacity.

20. The user equipment of claim 18, wherein the processor is further configured to quantize the matrix of singular vectors using a k-bit unitary codebook and the criterion to form a k-bit series of quantization bits and a quantized matrix of singular vectors.

21. The user equipment of claim 20, wherein the processor is further configured to perform unitary transformation, based on the transmission rank, on the quantized matrix of singular vectors to align the quantized matrix of singular vectors to the unquantized matrix of singular vectors to form an aligned matrix of singular vectors.

22. The user equipment of claim 21, wherein the channel estimator is further configured to encode the quantized matrix of singular vectors using a code to form the digital information.

23. The user equipment of claim 21, wherein the channel estimator is further configured to calculate the analog information as the error estimation between the quantized matrix of singular vectors and the aligned matrix of singular vectors.

24. An apparatus, comprising:
a receiving unit for receiving and decoding feedback received from a user equipment in the form of a digital information representing quantized channel parameter estimation information and an analog information representing an error estimation of the digital information, and
a transmitting unit adapted to adjust a transmission parameter based on the feedback and configured to transmit downlink data to a user equipment.

25. The apparatus of claim 24, wherein the transmitters transmit the decoded feedback data to a second base station, and wherein the second base station adjusts its transmission parameter based on the decoded feedback.

26. The apparatus of claim 25, wherein the second base station can only transmit on the downlink.
